(19) United States
(12) Patent Application Publication
(10) Pub. No.: US 2004/0105200 A1
(43) Pub. Date: Jun. 3, 2004

(54) Inverter apparatus, drive control apparatus, and drive control method

(76) Inventors: Shigeki Ikeda, Aichi-ken (JP); Seiki Sakata, Aichi-ken (JP); Satoshi Watanabe, Aichi-ken (JP); Masanori Tsuzuki, Aichi-ken (JP)

Correspondence Address: MORGAN & FINNEGAN, L.L.P., 345 Park Avenue, New York, NY, 10154, US

(21) Appl. No.: 10/722,600

(22) Filed: Nov. 25, 2003

(30) Foreign Application Priority Data
Dec. 2, 2002 (JP) 2002-350105

(51) Int. Cl. H02H 7/00

(52) U.S. Cl. 361/22

(57) ABSTRACT

An inverter apparatus includes an inverter for driving a 3-phase motor, a power supply circuit for applying direct current voltage to the inverter, a switching element mounted above and below an arm of each phase, a smoothing capacitor for protecting a voltage applied to the inverter from reaching a value equal to or larger than a predetermined value, and a control circuit for generating a control signal for control of an ON/OFF switching operation of each switching element. The control signal is generated by the control circuit such that the ON timing of each switching element of each phase can be shifted from each other.

### BACKGROUND OF THE INVENTION

1. Field of the Invention

The present invention relates to an inverter apparatus, and more specifically to an inverter apparatus, a drive control apparatus, and a drive control method for a motor mounted in a compressor, etc.

2. Description of the Related Art

FIG. 1A shows an example of a circuit of an existing inverter apparatus.

An inverter apparatus 30 shown in FIG. 1A controls the drive of, for example, a 3-phase (U phase, V phase, and W phase) motor mounted in a compressor, etc.

The inverter apparatus 30 includes an inverter 31 for driving a 3-phase motor by generating alternating current having a phase difference of 120°, a power supply circuit 32 for supplying power to a switching element 33 (SW1 through SW6) provided above and below each phase of the inverter 31, a smoothing capacitor 34 for restricting the voltage applied from the power supply circuit 32 to each switching element 33, and a control circuit 35 for generating a control signal (pulse wave) for control of a switching operation of ON/OFF of each switching element 33.

Each switching element 33 is provided with a control signal from the control circuit 35, and periodically performs a switching operation. 120° shift alternating current flows through each phase, and a 3-phase motor not shown in the attached drawings can be driven.

FIG. 1B shows a waveform of a control signal input to each switching element 33 of each phase.

As shown in FIG. 1B, the same ON timing of a control signal is input to each switching element 33 of each phase in the inverter apparatus 30. That is, for example, when the SW2 (U phase), the SW4 (V phase), and the SW6 (W phase) are turned to the ON positions, the same phase of the control signal is input to the three switching elements 33. Thus, since the ON timing of the switching element 33 of each phase is the same, ripple current is generated in the smoothing capacitor 34 with the ON timing. When the smoothing capacitor 34 is selected, it is necessary to prepare a large capacity smoothing capacitor 34 with the ripple current taken into account. There is a possibility that the ripple current may decrease the durability of the smoothing capacitor 34.

Japanese Patent Application Laid-open No. 2000-78850 describes a method for suppressing ripple current generated in a smoothing capacitor although it is different in configuration from the inverter apparatus 30 shown in FIG. 1A. It relates to a method for suppressing the ripple current generated in the smoothing capacitor commonly used in two inverters sharing one power supply circuit in an inverter apparatus. This suppressing method is realized by shifting by π the phase of each reference signal (carrier signal) used in the two inverters, thereby offsetting the ripple current flowing through the respective inverters, and suppressing the ripple current generated in the smoothing capacitor commonly used by the two inverters.

However, the method described in Japanese Patent Application Laid-open No. 2000-78850 is used to suppress the ripple current generated by two inverters. Therefore, in one of the two inverters, the ripple current flowing in the inverter is the same as the ripple current flowing through the inverter apparatus 30. Thus, in the technology of Japanese Patent Application Laid-open No. 2000-78850, the ripple current flowing through one of the two inverters is not suppressed. As a result, it is necessary to increase the capacity of the smoothing capacitor, thereby unfavorably upsizing the entire apparatus. Furthermore, the durability of the smoothing capacitor as well as the inverter apparatus 30 may be decreased.

### SUMMARY OF THE INVENTION

The present invention aims at providing an inverter apparatus, a drive control apparatus, and a drive control method capable of suppressing the load of a smoothing capacitor by ripple current even though only one inverter is used with one power supply. The present invention is configured as follows.

That is, in the inverter apparatus according to the present invention, a bridge circuit including a plurality of switching elements and a smoothing capacitor are connected in parallel to direct current power, and each of the plurality of switching elements is turned on and off according to the control signal output from the control circuit, thereby converting the direct current from the direct current power into multiphase alternating current. The control circuit outputs the control signal by shifting from others the ON operation timing of each of a plurality of switching elements in each control cycle.

As described above, by shifting from the others the ON operation timing of each of the switching elements, overlaps of the ON period of each switching element can be reduced, thereby suppressing the ripple current generated in the smoothing capacitor, requiring a smaller capacity of a smoothing capacitor, and downsizing the entire apparatus. Furthermore, since the ripple current can be suppressed, the decrease in durability of the smoothing capacitor can be suppressed.

The above-mentioned inverter apparatus can also be designed to allow the control circuit to instruct each switching element to generate a control signal having a predetermined phase difference.

Thus, the ON operation timing of each switching element is shifted, and the ripple current generated in the smoothing capacitor can be suppressed, thereby reducing the requirement for the capacity of the smoothing capacitor, and downsizing the entire apparatus. Furthermore, since the ripple current can be reduced, the decrease in durability of the smoothing capacitor can be suppressed.

The inverter apparatus can also be designed to allow the control circuit to instruct each switching element to generate a control signal using a carrier signal having, a predetermined phase difference.

Normally, the carrier signal is a reference signal for generation of the control signal, and a control signal of each phase (each switching element) is generated from one carrier signal. In the inverter apparatus according to the present invention, the carrier signal is prepared for each phase, and the phase of each carrier signal is shifted.

Thus, the ON operation timing of each switching element is shifted, thereby suppressing the ripple current generated in a smoothing capacitor. As a result, the requirement for the capacity of the smoothing capacitor can be reduced, and the entire apparatus can be downsized. Since the ripple current can be suppressed, the decrease in durability of the smoothing capacitor can be suppressed.

The above-mentioned inverter apparatus can also be designed to allow the control circuit to instruct the switching element to generate a control signal using a carrier signal modulated in a predetermined cycle.

Thus, the ON operation timing of each switching element is shifted, thereby suppressing the ripple current generated in a smoothing capacitor. As a result, the requirement for the capacity of the smoothing capacitor can be reduced, and the entire apparatus can be downsized. Since the ripple current can be suppressed, the decrease in durability of the smoothing capacitor can be suppressed. Furthermore, since the order of the ON operation timing of each switching element is changed, the order of the ON operation timing of the switching element of each phase can be switched in a control cycle. Thus, the control signal of each phase can be equally controlled in time in a control cycle, and the variation of a load with the ON/OFF timing of each switching element can be reduced.

Additionally, the inverter apparatus can also be designed to control the drive of a motor mounted in a compressor.

Thus, the ripple-current suppressed inverter apparatus is used as an inverter apparatus for driving the motor of a compressor so that the smoothing capacitor can be downsized, thereby downsizing the entire apparatus forming a compressor.

The scope of the present invention includes a drive control apparatus for control of the ON or OFF operation of a switching element provided for each of the above-mentioned phases and its drive control method.

### BRIEF DESCRIPTION OF THE DRAWINGS

FIG. 1A shows an example of a circuit of the existing inverter apparatus;

FIG. 1B shows the waveform of a control signal in the existing inverter apparatus;

FIG. 2A shows an example of a circuit of the inverter apparatus according to an embodiment of the present invention;

FIG. 2B shows the waveform of a control signal in the inverter apparatus according to an embodiment of the present invention; and

FIG. 3 shows the waveform of another control signal in the inverter apparatus according to an embodiment of the present invention.

### DESCRIPTION OF THE PREFERRED EMBODIMENT

An embodiment of the present invention is described below by referring to the attached drawings.

<First Embodiment>

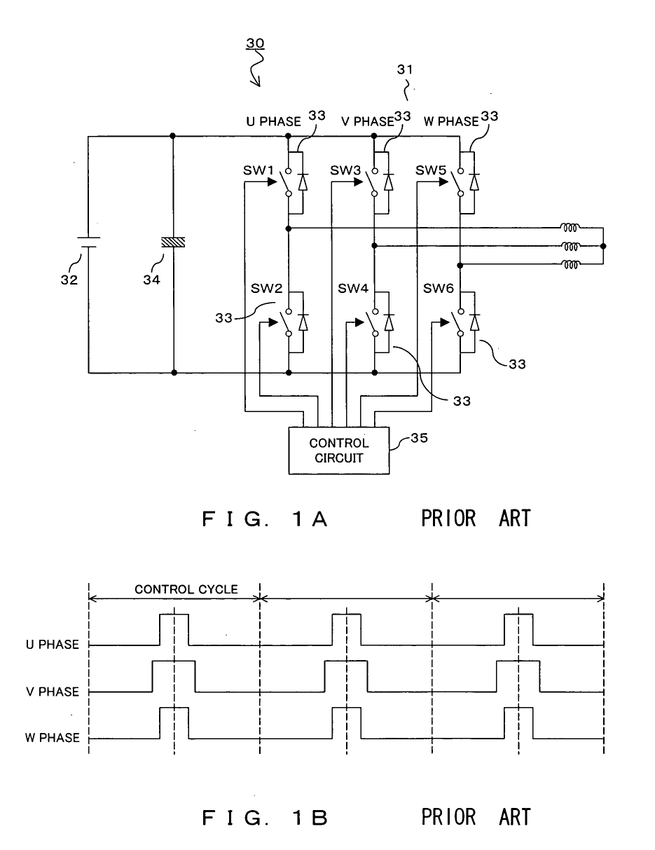

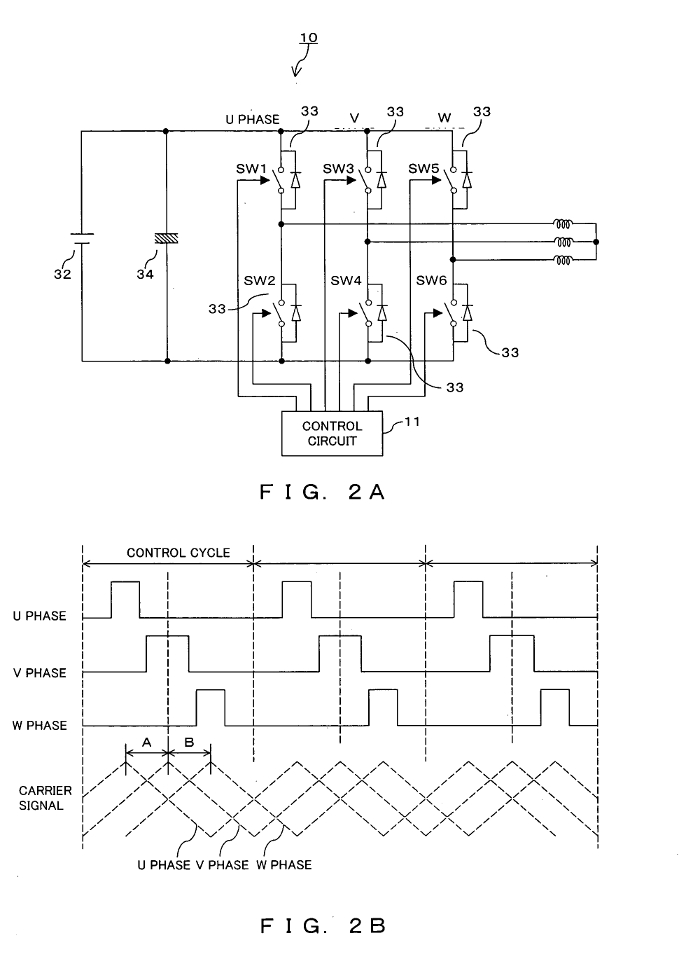

FIG. 2A shows an example of a circuit of the inverter apparatus according to an embodiment of the present invention. The same configuration as the inverter apparatus 30 shown in FIG. 1A is assigned the same symbol, and the detailed explanation of the configuration is omitted.

The control signal output by a control circuit 11 of an inverter apparatus 10 according to an embodiment of the present invention is different from the control signal output by the control circuit 35 of the inverter apparatus 30. Described below is the control signal output by the control circuit 11.

FIG. 2B shows the waveform of a control signal output by the control circuit 11.

The waveform of the control signal shown in FIG. 2B is the waveform of the control signal output by the control circuit 11 to each switching element 33 of each phase, for example, a waveform of a control signal when the SW2 (U phase), SW4 (V phase), and SW6 (W phase) of the switching element 33 is put in the ON position. As shown in FIG. 2B, the ON timing of the switching element 33 of each phase is shifted by a predetermined interval in a control cycle. That is, each control signal for the switching element 33 of each phase is shifted from each other by a predetermined phase difference.

In the control circuit 35 of the inverter apparatus 30 shown in FIG. 1A, each control signal for the switching element 33 of each phase is generated according to one reference signal (carrier signal). That is, for example, the control circuit 35 compares the voltage value of one reference signal with the command value (voltage value) for generation of desired alternating current for each phase. When the voltage value of the reference signal is larger than the command value, an ON timing is determined. If it is smaller, an OFF timing is determined. Thus, each ON timing of the switching element 33 of each phase falls in synchronization, and ripple current is generated in the smoothing capacitor 34 in which the ON timing overlap each other. Then, the inverter apparatus 30 changes the DUTY value of each control signal, thereby generating 120° phase shifted alternating current among the phases.

On the other hand, in the inverter apparatus 10 according to the present embodiment, a reference signal is prepared for each phase, and the phase of the reference signal of each phase is shifted such that the ON period of each phase cannot overlap each other based on the DUTY value of each phase, thereby shifting the ON timing of the control signal. Then, the inverter apparatus 10 generates alternating current different in phase by 120° for each phase. The control cycle shown in FIG. 2B is an ON/OFF operation cycle of each switching element 33 of each phase, and it is possible to shift the phase of the reference signal in the control cycle. That is, “A” shown in FIG. 2B indicates the level of the phase difference between the reference signal of the U phase and the reference signal of the V phase, and “B” indicates the level of the phase difference between the reference signal of the V phase and the reference signal of the W phase. Each phase of the reference signal of each phase (U phase, V phase, and W phase) can be shifted within 120°. The ON period of each switching element 33 of each phase can somewhat overlap (or somewhat separate from) each other, but the smaller the overlaps, the less ripple current generated in the smoothing capacitor 34.

Thus, by shifting the ON timing of each switching element 33 of each phase in a control cycle, the ripple current generated in the smoothing capacitor 34 can be suppressed, thereby reducing the requirement for the capacity of the smoothing capacitor 34. Thus, the smoothing capacitor 34 can be downsized. Therefore, the entire inverter apparatus 10 can be downsized and the flexibility in design can be improved.

Furthermore, since the ripple current generated in the smoothing capacitor 34 can be suppressed, the decrease in durability of the smoothing capacitor 34 can be reduced, and the reliability of the entire inverter apparatus 10 can be improved.

The noise generated by the ON or OFF of the switching element 33 of each phase with the same timing can be reduced by shifting the ON timing.

Additionally, the inverter apparatus 10 comprising the control circuit 11 for generating the above-mentioned control signal can be applied to an inverter apparatus for driving the motor, etc. of a compressor for use in a car. Thus, the smoothing capacitor 34 can be downsized, thereby downsizing the entire apparatus forming a compressor.

<Second Embodiment>

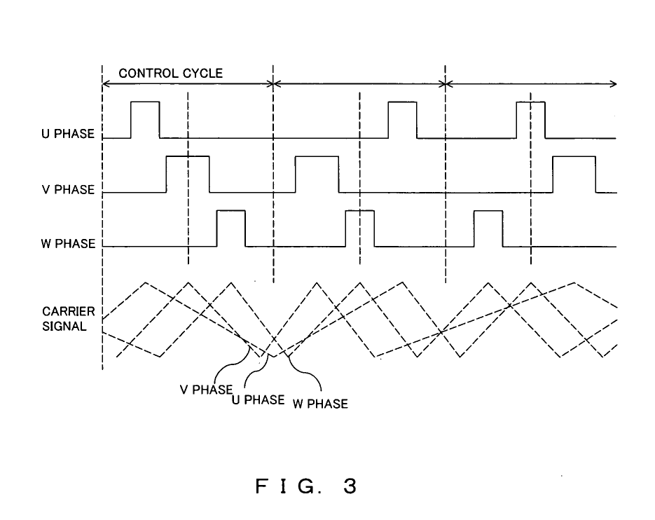

FIG. 3 shows the waveform of another control signal output by the control circuit 11 of the inverter apparatus 10.

The waveform of the control signal shown in FIG. 3 is a waveform of the control signal output from the control circuit 11 to the switching element 33 of each phase as with the control signal shown in FIG. 2B. For example, the control signal waveform is formed when the SW2 (U phase), SW4 (V phase), and SW6 (W phase) of the switching element 33 are put in the ON position.

Furthermore, as for the waveform of the control signal shown in FIG. 3, as with the waveform of the control signal shown in FIG. 2B, the ON timing of each switching element 33 of each phase is shifted in a control cycle. By putting each switching element 33 in the ON position using each control signal, 120° phase shifted alternating current is generated in each phase.

Using the control signal shown in FIG. 3, the ON timing of each switching element 33 of each phase is shifted, and the order of each ON timing is changed in the control cycle. For example, in the leftmost control cycle shown in FIG. 3, the control signal is generated such that the switching element 33 of each phase can be put in the ON position in the order of the U phase, V phase, and W phase. In the middle control cycle shown in FIG. 3, the control signal is generated such that the switching element 33 of each phase can be put in the ON position in the order of the V phase, W phase, and U phase. In the rightmost control cycle shown in FIG. 3, the control signal is generated such that the switching element 33 of each phase can be put in the ON position in the order of the W phase, U phase, and V phase. Thus, the control signal shown in FIG. 3 changes the order of the ON timing of each switching element 33 of each phase in each control cycle.

That is, the control signal shown in FIG. 3 prepares each carrier signal for each phase such that the phase of the carrier signal can be shifted from each other, and the frequency of each carrier signal can be different from each other. Thus, the order of the ON timing of the switching element 33 of each phase can be changed. The phase and the frequency of a carrier signal can be changed either regularly or at random.

As described above, by shifting the ON timing of each switching element 33 of each phase in a control cycle, and changing the order of the ON timing, the ripple current generated in the smoothing capacitor 34 can be suppressed. Therefore, the smoothing capacitor 34 can be downsized, and the entire inverter apparatus 10 can also be downsized and the flexibility in design can be improved.

Additionally, by switching the order of the ON timing of the switching element 33 of each phase, the control signal of each phase can be controlled equally in time in the control cycle. Therefore, the variation in load in the ON/OFF position of each switching element 33 can be reduced.

Furthermore, since the ripple current generated in the smoothing capacitor 34 can be suppressed, the decrease in durability of the smoothing capacitor 34 can be reduced, and the reliability of the entire inverter apparatus 10 can be enhanced.

The noise generated by turning ON or OFF with the same timing among the switching elements 33 of the respective phases can be reduced by shifting the ON timing.

Additionally, the inverter apparatus 10 comprising the control circuit 11 for generating the above-mentioned control signal can be applied to an inverter apparatus for driving the motor, etc. of a compressor for use in a car. Thus, the smoothing capacitor 34 can be downsized, thereby downsizing the entire apparatus forming a compressor.

The above-mentioned switching element 33 can also be configured using a CMOSFET (complementary metal oxide semiconductor field-effect transistor) or a bipolar transistor.

As described above, using the inverter apparatus 10, by shifting the ON timing of each switching element 33 of each phase in a control cycle, the ripple current generated in the smoothing capacitor 34 can be suppressed, thereby reducing the requirement for the capacity of the smoothing capacitor 34. Thus, the smoothing capacitor 34 can be downsized. Therefore, the entire inverter apparatus 10 can be downsized. Furthermore, since the ripple current generated in the smoothing capacitor 34 can be suppressed, the decrease in durability of the smoothing capacitor 34 can be reduced. Additionally, the inverter apparatus 10 comprising the control circuit 11 for generating the above-mentioned control signal can be applied to an inverter apparatus for driving the motor, etc. of a compressor. Thus, the smoothing capacitor 34 can be downsized, thereby downsizing the entire apparatus forming a compressor.

What is claimed is:

1. An inverter apparatus in which a bridge circuit having a plurality of switching elements and a smoothing capacitor are connected in parallel to direct current power, and each of the plurality of switching elements is turned on and off according to a control signal output from a control circuit, thereby converting direct current from the direct current power into multiphase alternating current, wherein
said control circuit outputs the control signal by shifting from others an ON operation timing of each of a plurality of switching elements in each control cycle.

2. The apparatus according to claim 1, wherein
said control circuit generates a control signal having a predetermined phase difference for each switching element.

3. The apparatus according to claim 1, wherein
said control circuit generates a control signal for each switching element using a carrier signal having a predetermined phase difference.

4. The apparatus according to claim 1, wherein
said control circuit generates a control signal for each switching element using a carrier signal modulated in each predetermined cycle.

5. The apparatus according to claim 1, wherein
said inverter apparatus controls drive of a motor mounted in a compressor.

6. A drive control apparatus which is used for an inverter, generates alternating current having a predetermined phase difference for each of a plurality of phases, and drives a motor, wherein
an ON operation timing of a switching element mounted for each phase is shifted.

7. A drive control method which is used for an inverter, generates alternating current having a predetermined phase difference, and drives a motor, wherein
an ON operation timing of a switching element mounted for each phase is shifted.
